(19) United States
(12) Patent Application Publication
(10) Pub. No.: US 2025/0370970 A1
(43) Pub. Date: Dec. 4, 2025

(54) METHODS AND SYSTEMS FOR IMPROVED DATA TRUST SCORES

(71) Applicant: QlikTech International AB, Lund (SE)

(72) Inventors: Don Pinto, Toronto (CA); Sebastiao Correia, Paris (FR); Simon Daniel Swan, King of Prussia (GB)

(21) Appl. No.: 19/226,478

(22) Filed: Jun. 3, 2025

Related U.S. Application Data
(60) Provisional application No. 63/655,231, filed on Jun. 3, 2024.

(51) Int. Cl. G06F 16/215; G06F 16/23; G06F 16/26

(52) U.S. Cl. CPC G06F 16/215; G06F 16/2365; G06F 16/26

(57) ABSTRACT

Described herein are methods and systems for evaluating datasets through a multi-faceted scoring approach that assesses data quality across multiple dimensions. A trust score for a dataset may be generated by a scoring engine and displayed on a user interface, providing a comprehensive assessment of the dataset's readiness for use in artificial intelligence applications. The trust score incorporates multiple dimensions including diversity, timeliness, accuracy, security, discoverability, and LLM-readiness, offering users quantitative insights into dataset quality. This scoring system enables organizations to identify high-quality datasets suitable for AI model training, reducing the risk of poor model performance due to inadequate data. The visualization of trust scores through intuitive interfaces allows data scientists, analysts, and other stakeholders to quickly assess and compare datasets, facilitating more informed decision-making in AI development processes.

### CROSS-REFERENCE TO RELATED PATENT APPLICATION

This application claims priority to U.S. Prov. App. No. 63/655,231, filed on Jun. 3, 2024, the entirety of which is incorporated by reference herein.

### BACKGROUND

Artificial Intelligence (AI) systems often rely on large datasets for training and operation. These datasets may contain structured or unstructured data from various sources. The quality of these datasets may be a key factor in the performance of AI systems. In modern enterprise environments, metadata may be siloed, inconsistently maintained, and difficult to operationalize. Data quality assessments may be manual or fragmented. Job structures may be opaque. Pipeline health may be rarely monitored in a cohesive fashion. These issues may lead to decreased data trust, operational inefficiencies, and significant challenges in enforcing compliance and governance at scale. These and other considerations are discussed herein.

### SUMMARY

It is to be understood that both the following general description and the following detailed description are exemplary and explanatory only and are not restrictive. Described herein are methods and systems for generating a trust score(s) for datasets. The trust score may be based on a plurality of dimensions, such as diversity, timeliness, accuracy, security, discoverability, and LLM-readiness. The trust score may be visualized in a way that provides quantitative information to assess and understand datasets, particularly in the context of Artificial Intelligence (AI) data readiness.

The present methods and systems may introduce a standardized, governed method of extracting and utilizing metadata from profiling tools, job design files, and runtime systems. Each component may be designed to be modular and extensible. This modular design may enable enterprise-wide observability and intelligent decision-making capabilities. A significant innovation may lie in the consolidation of profiling, auditing, and collection into a single, governable architecture with embedded AI augmentation and accessibility features. The application of a persistent, lifecycle-aware trust score may differentiate this approach from traditional data quality or observability tools. The trust score may provide enhanced capabilities for assessing dataset readiness across the full enterprise data lifecycle.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system;

FIG. 1B shows an example system;

FIG. 2 shows an example diagram with example dimensions of a trust score;

FIG. 3 shows an example system architecture and an example process flow for generating a trust score;

FIG. 4 shows an example user interface;

FIG. 5 shows an example process flow diagram;

FIG. 6 shows an example flowchart of a process flow;

FIG. 7 shows an example data mart;

FIG. 8 shows an example data mart schema;

FIG. 9 shows an example dashboard for assessing a trust score;

FIG. 10 shows an example trust score report;

FIG. 11 shows an example trust score visualization;

FIG. 12 shows an example system.

FIG. 13 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration comprises from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description comprises cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Described herein are systems and methods for assessing the readiness of datasets for use in artificial intelligence (AI) applications. These systems and methods may provide an improved scoring system that evaluates datasets based on a plurality of dimensions, such as diversity, timeliness, accuracy, security, discoverability, and Large Language Model (LLM) Readiness. This scoring system may provide a trust score for a dataset(s). The trust score may provide a quantitative and visual representation of a dataset's readiness for AI use, thereby facilitating more informed decision-making in the selection and utilization of datasets for AI applications.

The systems and methods may comprise a modular and extensible system that enables the extraction, evaluation, and centralized management of metadata across a full enterprise data lifecycle. The system may significantly improve accessibility, trust, and manageability of data by standardizing and automating profiling, auditing, and runtime metadata collection. The system may be designed for integration across teams, systems, and AI-assisted workflows. The architecture may provide the foundation for intelligent data access and lifecycle governance. The system may enable organizations to better understand and manage their data assets throughout the entire data lifecycle. The modular design may allow for flexible deployment and customization based on specific enterprise requirements and existing infrastructure.

In some aspects, the trust score system described herein may include a scoring engine that determines trust scores for datasets based on the plurality of dimensions. The scoring engine may provide a user interface for users to view attributes and characteristics of datasets. This user interface may display a trust score for each dataset in a dataset inventory, providing visual and quantitative information to assess and easily understand the readiness of the datasets for AI use. In some cases, the trust score system may include various factories, such as a profiling factory, a collection factory, and an auditing factory, that process data and generate metrics for the plurality of dimensions of the trust score. These “factories” may interact with a data mart, which serves as a central repository for processed data and metrics. The data mart may capture all events related to incoming metrics and associated data with a timestamp, allowing the system to consider the history and development of the dimensions for a particular dataset(s).

In some examples, the trust score system may employ data security measures to protect datasets from unauthorized use. These measures may include data detection and classification of Personally Identifiable Information (PII), as well as data protection features such as hashing, masking, and encryption. These measures help to safeguard sensitive information and ensure user privacy, which is particularly pertinent in the context of AI applications. In some aspects, the trust score system may provide a report for a trust score, which may be output to a computing device via a user interface. This report may provide valuable insights into the readiness of a dataset for AI use. In some cases, the trust score system may be implemented across various industries and fields that rely on high-quality data for AI applications. By providing a comprehensive, easy-to-understand trust score for datasets, the system may help users identify and utilize the datasets that are the readiest for AI use, thereby improving the efficiency and effectiveness of AI applications.

The present systems and methods may provide various improvements over existing trust score systems that may focus on criteria that are less-useful in assessing AI readiness. By contrast, the present systems and methods evaluate datasets across a broader, more comprehensive range of dimensions, including diversity, timeliness, accuracy, security, discoverability, and LLM-readiness. This multi-dimensional analysis provides a more holistic view of a dataset's strengths and potential weaknesses, enabling users to make more informed decisions about their data selection and utilization.

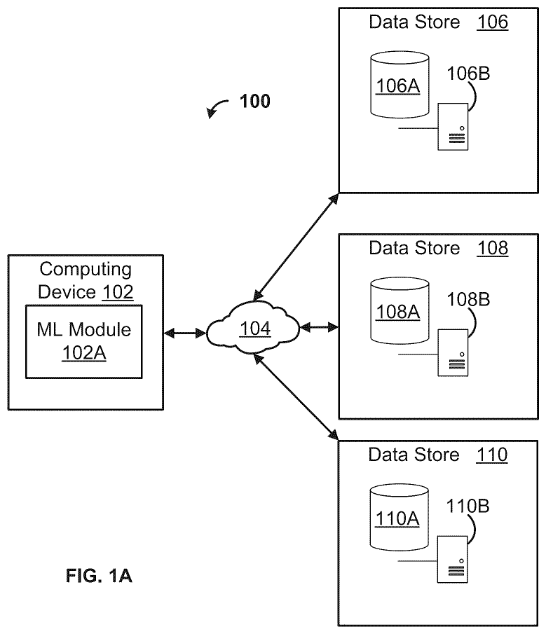

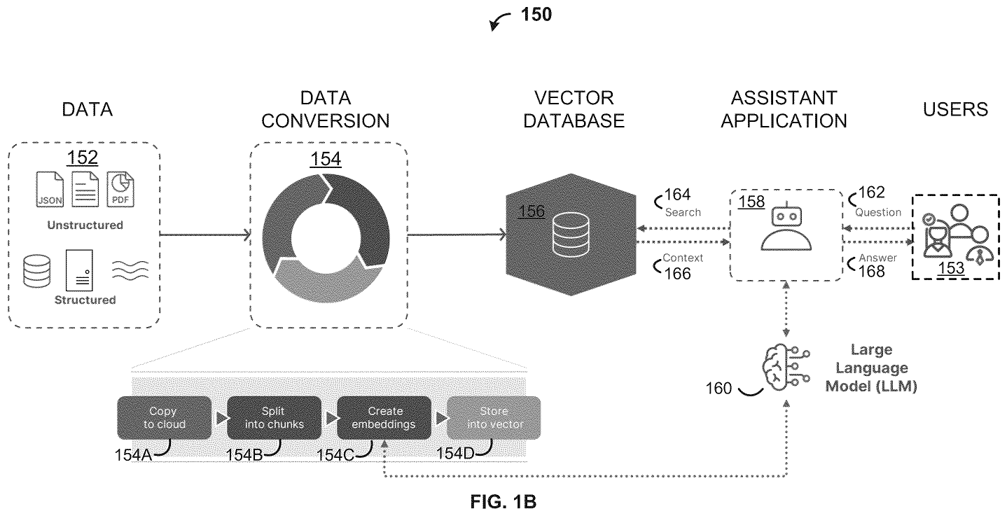

Turning now to FIG. 1A, a block diagram of an example system 100 is shown. The system 100 may comprise a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as one or more neural networks, Large Language Models (LLMs), segmentation models, ensemble models, a combination thereof, and/or the like. Though the ML module 102A is shown in FIG. 1A as being resident at the computing device 102, it is to be understood that the ML module 102A may be resident at one or more computing devices that may be local or remote to the computing device 102. Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

The ML module 102A may be a software component on the computing device 102. The ML module 102A may include, or be in communication with, one or more machine learning models, such as large language models (LLMs), that are trained to perform various tasks. For example, the ML module 102A may send requests to the servers 106B, 108B, 110B to retrieve data from the data stores 106, 108, 110. The servers 106B, 108B, 110B may respond to these requests by sending the requested data back to the ML module 102A over the network 104.

In some aspects, the system 100 may be adapted to process various types of data sources. For instance, the system 100 may be configured to handle structured data sources. These structured data sources may include databases or spreadsheets, which typically organize data in a structured manner, such as in rows and columns. The computing device 102 may access these structured data sources via the network 104, and the ML module 102A may process the structured data.

In some cases, the system 100 may be adapted to process semi-structured and/or unstructured data sources. Semi-structured data sources may include XML or JSON files, which provide some level of data organization through tags and attributes, but do not conform to the rigid structure of databases or spreadsheets, while unstructured data may comprise file-based sources, such as presentations, mail archives, text documents, PDFs, transcripts, etc. The computing device 102 may access such data sources via the network 104.

In other cases, the system 100 may be adapted to process real-time data streams or data feeds. Real-time data streams or data feeds may include data that is continuously generated and transmitted, such as sensor data, social media feeds, financial market data, etc. The computing device 102 may access these real-time data streams or data feeds via the network 104, and the ML module 102A may process the real-time data. In each of these cases, and as further described herein, the data from the various data sources may be transformed into a format that may be consumed by an LLM.

FIG. 1B shows an example system 150. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 (e.g., a NL query) to the assistant application 158. The assistant application 158 may perform a search 162 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create —and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

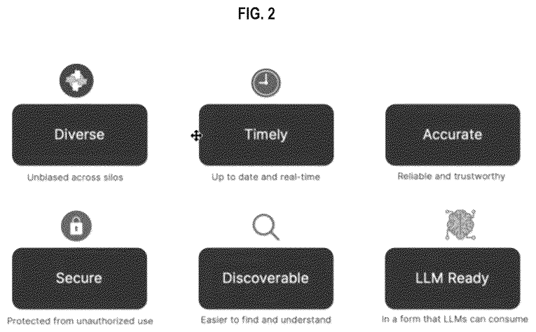

Referring now to FIG. 2, a diagram illustrating example dimensions for a trust score are shown. The dimensions in this example include: “Diverse,” “Timely,” “Accurate,” “Secure,” “Discoverable,” and “LLM Ready.” The “diverse” dimension of the trust score ensures that data comes from a wide range of sources, reducing bias and improving fairness in AI applications. The “timely” dimension of the trust score focuses on delivering fresh, real-time data to keep AI models current and relevant. The “accurate” dimension of the trust score emphasizes the importance of correct, high-quality data to prevent biased outputs and ensure reliable AI performance. The “secure” dimension of the trust score protects sensitive data through classification, masking, encryption, and access control to maintain privacy and model integrity. The “discoverable” dimension of the trust score ensures data is easily accessible and searchable using metadata, semantic typing, and business glossaries. The “LLM-ready” dimension of the trust score indicates the data has been prepared in a format(s) suitable for machine learning and large language models, enabling smooth ingestion and effective AI outputs.

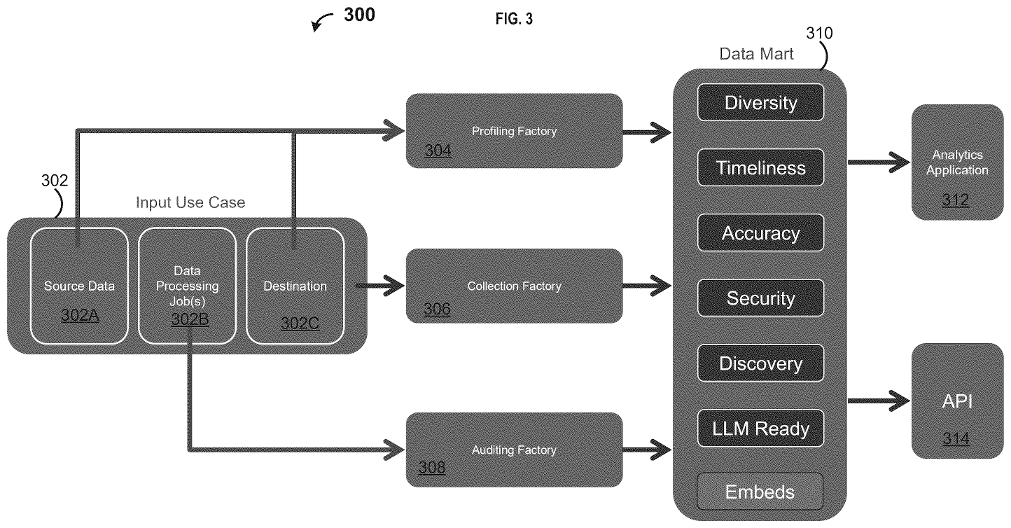

FIG. 3 shows an example system 300 for generating a trust score. The system 300 may comprise an input use case 302, which comprises source data 302A, data processing job(s) 302B, and a destination 302C. The source data 302A may include a variety of data types and formats, such as structured data, unstructured data, semi-structured data, and the like. The data processing job(s) 302B may include various data processing tasks, such as data cleaning, data transformation, data integration, and the like. The destination 302C may represent a location where the processed data is stored or used, such as a database, a data warehouse, a data lake, an application, and/or the like.

The system 300 may further comprises a profiling factory 304, a collection factory 306, and an auditing factory 308. These factories may process the data from the input use case 302 and may generate metrics for the plurality of dimensions of the trust score. The profiling factory 304 may evaluate the integrity, structure, and utility of datasets. The profiling factory 304 may apply both system-defined and user-defined rules to generate row-level and column-level metrics, statistical summaries, and anomaly detections. These outputs may be used to assess dataset readiness for analytics, governance, or AI use. Inputs to the profiling factory 304 may include data profiling services, columnar statistics, correlation analysis, and drift detection tools. Output metrics may include completeness, accuracy, pattern variability, and enrichment opportunities. These metrics may be used to inform catalog metadata, trust indicators, and profiling-based suggestions for improvement. The profiling factory 304 may support broad use cases such as dataset evaluation, report trust scoring, data product certification, and self-service readiness across various organizational roles.

The collection factory 306 may gather runtime metadata from operational systems and APIs. The collection factory 306 may collect data from cloud environment components, job execution logs, and dataset access telemetry. The collection factory 306 may collect task success and failure rates, PII classification status, dataset usage, and runtime errors. This information may enable monitoring of operational health, service label agreement validation, and risk identification across environments. The collection factory 306 may provide cross-team visibility and may enable downstream systems to act on live metadata through governed access endpoints.

The auditing factory 308 may provide structural analysis of job definitions. The auditing factory 308 may parse design files to extract job flow details, component usage, and source-target mappings. The design files may comprise .item XML files, in some cases. The auditing factory 308 may identify complexity, modularity, and adherence to engineering standards. The auditing factory 308 may help determine whether jobs meet design and compliance guidelines, whether they contain AI-specific logic, and whether they are properly cataloged and governed. Use cases may include job health evaluation, CI/CD promotion criteria, pipeline documentation enhancement, and lifecycle maintainability assessment.

Returning to the collection factory 306, it may focus on collecting metadata and performing specialized analyses that complement raw profiling. It may aggregate information from various sources related to the dataset's context and schema. In practice, the collection factory 306 may gather metadata from the data integration pipeline, data catalog, or the data storage layer. For example, it may retrieve the schema definition (field names, types), data lineage information, or associated business glossary terms from a catalog. The collection factory 306 may also extract trust score-specific metrics such as detected Personally Identifiable Information (PII) and semantic type classifications of the data fields. This means it may run algorithms to scan the dataset's content or use existing metadata to identify if any field contains emails, phone numbers, social security numbers, names, or other sensitive information. The collection factory 306 may also assign semantic categories to fields based on patterns or dictionary matching. For instance, it could recognize a column as “Address” or “Country” or “Product ID” based on content analysis.

Identifying semantic types and PII may be important for both the Security dimension and the Accuracy/Validity dimension of the trust score. For the Security dimension, the collection factory 306 may flag unprotected sensitive data. For the Accuracy/Validity dimension, it may check if values match the expected semantic type. The collection factory 306 may also compute metrics like the number of different data sources feeding into the dataset or the presence of documentation. These metrics could feed into the Discoverability dimension. For instance, a dataset with rich metadata and tags may be more discoverable than one with none, and the collection factory 306 could count those tags and annotations.

The output of the collection factory 306 may be a set of metadata-driven metrics and flags. These may be provided to a data mart 310. The data mart 310 may serve as a central repository for the processed data and metrics. The data mart 310 may store the processed data along with (or the data may be indicative of) the plurality of dimensions, such as diversity, timeliness, accuracy, security, discoverability, and LLM Readiness. The data mart 310 may capture all events related to incoming metrics and associated data with a timestamp, allowing the system to consider the history and development of the dimensions.

For each dataset processed, the collection factory 306 may store entries such as: list of PII fields found, yes/no flags for encryption or masking detected on those fields, count of semantic types identified, list of tags or custom attributes present, and other relevant metadata. All these may be timestamped in the data mart 310 as well. By collecting this information centrally, the system may ensure that whenever a trust score is requested, the scoring engine can pull from the data mart 310 the latest collected metadata about the dataset.

The collection factory 306 may typically be invoked when a new dataset is registered or when a dataset is updated. It may also run periodically to ensure metadata remains current. The collection factory 306 may retrieve information from source systems. For example, it may call an API of a data catalog for tags, or scan a sample of the dataset for PII. It may then process this information by applying detection algorithms and store the resulting metrics into the data mart 310. In a practical example, the collection factory 306 may identify PII in a data integration job's output dataset and supply that information to the trust scoring process.

The auditing factory 308 may be a unique component that inspects the data processing jobs or pipelines that produce or handle the dataset, rather than the dataset itself. In other words, it may audit the ETL/ELT process to glean information about how the data was obtained and transformed. The auditing factory 308 may parse job definitions and extract component-level details. For example, it may determine how many source components feed into the job (number of input data sources) and how many output targets there are, what types of transformations are used (joins, aggregations, filters, machine learning components, etc.), and the connectivity or dependencies between steps. It may classify components by type, which might reveal the complexity or nature of the data flow.

Significantly, the auditing factory 308 may also look for the presence of AI-related components in the job, such as calls to external AI services or specific machine learning operations. For instance, if the pipeline includes a component that calls an AI API or implements a Retrieval-Augmented Generation (RAG) step, the auditing factory 308 may detect that and record it. This may be directly relevant to the LLM-Readiness dimension. A pipeline that already integrates LLM components or prepares embeddings might indicate the dataset is intended for such use, and the trust score might reflect whether the preparation is adequate. The auditing factory 308 may also note indicators of best practices or potential issues in the job: e.g., usage of data validation components, logging, error handling in the flow (which can correlate with data reliability).

After retrieving the job definition and configuration, and processing it to extract these details, the auditing factory 308 may store its findings in the data mart 310. The data mart 310 may thus have records like: number of sources=3, number of targets=1, job complexity rating=Medium, contains AI components=Yes (contains an AI API call), contains RAG=Yes, etc., all tied to the dataset or job ID. These auditing metrics may inform several trust score dimensions indirectly. For example, the Timeliness dimension could incorporate how frequently the job is scheduled to run. A job that runs daily may score higher in timeliness of data refresh than one that runs monthly. The Discoverability or Security dimensions might also be affected by pipeline factors. For instance, if the job includes components that publish metadata to a catalog, or if it includes encryption steps, these factors may influence the respective dimension scores.

The auditing factory 308 may provide a sense of data pipeline quality and AI-centric pipeline features. This may be an improvement over systems that might consider only the dataset in isolation. The auditing factory 308 considers how the data was produced. A robust, well-documented, and AI-integrated pipeline may increase confidence in the dataset. All such context from the auditing factory 308 may be preserved in the data mart 310 for use in scoring and for future analysis. The data mart 310 may even store the entire job file as a linked asset for reference.

The system 300 further comprises an analytics application 312 and an API 314. The analytics application 312 may provide various data analysis functionalities, such as data exploration, data visualization, data mining, predictive modeling, and the like. The API 314 may provide a programming interface for accessing and manipulating the data in the data mart 310. The analytics application 312 and the API 314 may utilize the data from the data mart 310 for further analysis and embedding processes, for example.

The data mart 310 may be implemented as a relational database or a data warehouse table set dedicated to the trust score system. It may be designed to store each piece of collected data along with context. This context may include which dataset the data pertains to, which factory provided it, timestamp information, and other relevant metadata. The data mart 310 may contain schemas or tables for different categories of information. For instance, a Measurements table might store profiling statistics for each dataset, a Metadata table might store PII/semantic information from the collection factory 306, an Audit table for pipeline audit metrics from the auditing factory 308, and a Summary table that could hold the latest computed trust scores or dimension scores for each dataset. The system may use naming conventions or a management process to map raw data quality metrics into the standardized trust score dimensions. For example, if a profiling metric is “% of empty values”, the data mart 310 might tag that under the Accuracy dimension category.

One of the critical roles of the data mart 310 may be to capture every metric update as an event with a timestamp. This may allow the system to maintain a historical log of how each dataset's metrics (and thereby trust score) change over time. By retaining this history, the data mart 310 may enable trend analysis. For example, one could query how the Accuracy dimension for a specific dataset has improved after a certain date when data cleaning was introduced, or see that the trust score dipped during a particular week due to a data load failure (reflected in increased missing values). This temporal aspect may be stored such that each entry (or set of entries) can be tied to a specific run of a factory or a specific dataset version. The historical storage in the data mart 310 may greatly improve the system's ability to perform audits, debugging, and even machine learning on the metrics themselves. For instance, the system could potentially predict future trust scores based on past trends.

The data mart 310 may serve as the single source of truth for the trust scoring system. Both the internal analytics application 312 and any external API 314 consumers may rely on the data mart 310 to fetch trust score data. When the scoring engine needs to calculate or update a trust score, it may pull the necessary metrics from the data mart 310 (which in turn were put there by the factories). Similarly, when an external query (via API 314) asks for the trust score of a dataset, the system can respond based on data mart 310 records.

Because of this central role, the data mart 310 may also implement some logic. For example, it may have an “acceptance criteria” table that defines acceptable ranges or minimum requirements for certain metrics. When new metrics arrive, the system may automatically flag if they violate acceptance criteria. The data mart 310 may also store raw assets for future analysis. It may keep a copy of the pipeline job files as linked assets, which can later be used by data scientists to train predictive models or analyze how pipeline structures correlate with trust outcomes. Another advanced aspect may be storing information about data embeddings: if part of the pipeline involves converting data to vector embeddings for an LLM, the data mart 310 can store metadata about those embeddings. For example, it may store distribution of vector values, or how much PII content ended up in the embeddings. This may tie into the LLM-Readiness dimension. The system may monitor not just the raw data, but also its embedded form for AI consumption.

In terms of processing flow, all three factories may deposit their outputs into the data mart 310 (either directly or via the scoring engine). The data mart 310 might trigger a consolidation routine that merges or “renames” certain metrics to align with the trust score dimensions schema. Then, a summary entry can be updated for that dataset's trust score. When a user or external system requests the trust score, the data mart 310 (through the engine) may provide the pre-calculated score and possibly the breakdown per dimension. If not pre-calculated, the engine may compute it on the fly using data mart 310 data. The data mart 310 may ensure that even if the underlying dataset or pipeline is updated, previous state is not lost. It may become a time-versioned record. This may be extremely useful for auditability and for continuous improvement of data quality. Teams can see the effect of their improvements reflected in the trust score over time.

To illustrate how the data mart 310 may operate in a real-world scenario, consider an example where a data engineer has created a data integration job that consolidates customer data from several sources into a unified dataset. This dataset (e.g., “Customer360”) may be loaded into a cloud data warehouse, and a business analyst wants to explore it and build AI-driven insights. Before trusting the results, the analyst may check the dataset's trust score which could be integrated into an analytics application via the trust score system's API 314.

When the data integration job for Customer360 runs, it may produce the integrated dataset in the target database. As part of this job execution (or immediately after), the trust score system may activate. The auditing factory 308 may read the job definition to interpret what happened in the data flow. It may find, for example, that the job pulled data from 3 source systems (e.g., a CRM database, an e-commerce database, and a marketing CSV file), merged them via join components, and output to one target table. It may also notice the job has a schedule of running nightly, and includes an AI API call component that, for example, standardizes free-text addresses using an LLM. The auditing factory 308 may classify each component (joins, API call, etc.) and count the sources/targets. It may flag the presence of the AI component (an AI-related step), which could be relevant to LLM-Readiness. All these findings (3 sources, 1 target, uses AI, runs nightly, etc.) may be written to the data mart 310 under the job's metadata record.

At the same time, the collection factory 306 may run to gather additional metadata. It may connect to the output dataset Customer360. It may read the schema (e.g., 50 columns including Name, Email, PurchaseHistory, etc.), and scan a sample of the data to detect PII. It may find that Email and Name fields likely contain PII (email addresses, personal names) and note whether they are encrypted or masked. For example, it might find that emails are hashed, but names are in plain text. It may also use a semantic library to identify semantic types: e.g., Email field is of type “Email Address” (user-created semantic type), a Country field is recognized as type “Country Name”, etc. The collection factory 306 may record that 2 PII fields were detected (Name, Email), with one protected (Email hashed) and one not (Name plaintext). It may also fetch any tags or descriptions the data engineer provided for the dataset in the catalog. For instance, the dataset might be tagged “Customer Data” and have a description mentioning it's a master customer view. These details may be collected as well (tags count=1, description length=X). All this may be sent to the data mart 310 as part of the dataset's profile.

Meanwhile, the profiling factory 304 may either be invoked by the data integration job or run on the new dataset to profile its content. It may calculate that Customer360 has, for example, 100,000 records, 50 columns, with 5% overall missing values. It may compute that the Email field is 100% populated (no nulls), Name field has 1% nulls, PurchaseHistory (which is a numeric field) has an average value of 5 purchases per customer, etc. It may also determine a data completeness ratio (valid vs invalid entries)—perhaps 95% completeness. It may note that according to the semantic type dictionary, 98% of values in the Country field correspond to known country names (validity measure). All these profiling stats may be written to the data mart 310.

Each factory may thus retrieve relevant information (job config, dataset content, metadata), process it (extract metrics and observations), and store the results in the data mart 310. The data mart 310 may now contain a comprehensive set of records for dataset Customer360: profiling metrics (completeness 95%, etc.), collection metrics (2 PII fields, 1 masked, tags present), auditing metrics (3 sources, AI component present, daily job). Each entry may be timestamped and linked to this job run.

With fresh data in the data mart 310, the trust score scoring engine may compute the trust score for Customer360. It may pull together the latest metrics for each dimension. For Diversity, using profiling info, perhaps it looks at how diverse key fields are. If Customer360 covers customers from 10 different countries and a wide age range, diversity might score high. The engine might quantify diversity as a function of cardinality in categorical fields, etc. For Timeliness, based on auditing info, the dataset is updated nightly (which is quite timely). Also, the data itself might have a “Last Transaction Date” field; if the most recent date is yesterday, that's very current. Timeliness likely scores high.

For Accuracy, this could take into account the completeness (95% complete is good) and semantic validity (Country field 98% valid entries). Also, if any data quality issues were found (say 5% of phone numbers were in a wrong format), it would lower accuracy. For Security, the engine may check PII findings. It may see PII exists; one field is protected (email hashed) but another (name) is not masked. It may also check if any “hard-coded credentials” or unsecured data were found in the pipeline. For instance, the auditing factory 308 might catch if the data integration job had an insecure component. The system may flag that not all PII is masked, so security gets a medium score. However, the presence of hashing on one field and encryption on some fields may be a plus.

For Discoverability, the engine may look at metadata availability. The dataset had a tag and description. Perhaps also multiple users have accessed it (if the system tracks usage or endorsements—this could come from a data catalog's info). With at least some documentation and tagging, discoverability may be moderate. If it had no description or tags, it would be low; if it had many tags, rich description, and perhaps user ratings, it would be high. For LLM-Readiness, because the auditing factory 308 noted an AI component and the data contains textual fields (like customer reviews maybe) that were processed, the dataset may be somewhat prepared for LLM use. However, if the data is not yet in vector form, LLM-readiness might not be full. The system may also check if embeddings are stored: suppose this job did not yet convert data to embeddings, so LLM-Readiness may be moderate—the data is clean text but not embedded. Additionally, the acceptance criteria might say that to be fully LLM-ready, certain fields (like long text) need to be vectorized or certain quality thresholds met; any shortfall keeps the score medium.

The scoring engine may apply weights to these dimension scores (perhaps each equally weighted by default). It may calculate an overall trust score (e.g., 82 out of 100) for Customer360. This trust score and the individual dimension values may be saved to the data mart 310 summary table, along with the timestamp and version. If any dimension failed the acceptance criteria (for example, if Security was below a defined threshold), the system would mark the dataset as “not AI-ready” in an internal flag. The trust score may now be ready to be served to users.

On an analytics application, the business analyst may open the application and select the Customer360 dataset to start building visualizations. Thanks to the integration, the app may automatically call the trust score system's API 314 (or query the data mart 310 via a connector) to fetch the latest trust score for Customer360. The response may return the trust score of 82, along with a breakdown: Diversity: High, Timeliness: High, Accuracy: High, Security: Medium, Discoverability: Low-Medium, LLM-Readiness: Medium (for instance). The application may display this information in the interface. This could be shown as a small overlay widget next to the dataset name—e.g., a colored gauge or icon indicating the score, which the user can hover over to see details.

In this example, the analyst may see a trust score of 82, indicating generally good data quality but with some concerns. By clicking on the trust score indicator, the analyst might open a more detailed trust score dashboard (either within the application via an embedded iframe or a new tab to the trust score system's UI). This dashboard may show each dimension with a rating (perhaps High/Medium/Low or numerical subscores). It may highlight that Security=Medium, and on inspection the analyst may find a note: “2 PII fields detected; 1 is unmasked.” They may also see Discoverability=Low, meaning the dataset lacks documentation—the dashboard might show “Only 1 tag, short description provided” as feedback. The other dimensions may be marked acceptable (green or “High”). There may also be a timeline graph showing that last week the trust score was 80 and it improved to 82 after some change (perhaps the addition of the hashing on emails improved Security slightly).

All this information may be fetched in real-time via the system's API 314 and data mart 310. The integration demonstrates the general-purpose applicability of the trust score system. The trust score could similarly be fetched in a notebook for data science, shown in a report, or used in an automated pipeline to decide if a dataset should be allowed for model training. The immediate benefit may be that the analyst can assess data trustworthiness at a glance, without leaving their analysis environment. This may help them decide how much to rely on the data. For instance, seeing a medium Security score, they might avoid using customer names in an AI model until those are masked (to comply with privacy). Seeing a low Discoverability score might prompt them to ask data engineers for more documentation.

After reviewing the trust score, suppose the analyst reports the findings to the data engineering team. They may decide to improve the dataset's trust score by addressing the flagged issues. They may update the data integration job to mask the customer Name field as well (improving Security), and add more documentation/tags in the data catalog for Customer360 (improving Discoverability). The next time the data integration job runs, the factories may collect the new information: the collection factory 306 may now find no exposed PII (all sensitive fields hashed or masked), and record that change; it may also find additional tags/description text. The data mart 310 may log these new metrics and the trust score may be recomputed, perhaps rising to 90 with Security now “High” and Discoverability “Medium”. The user may then see this updated score, reflecting a direct improvement in data readiness due to the team's action. This feedback loop may show how the system not only assesses but also encourages iterative improvement in data quality and AI readiness-a strong advantage over static or one-off data evaluation methods.

In some aspects, the system 100 may be utilized to process data stored at, for example, the first data store 106 for the creation of embeddings for a vector database. For example, the first server 106B may retrieve a dataset from the first database 106A, which may contain structured data such as customer transaction records. This dataset may then be transmitted over the network 104 to the computing device 102, where the ML module 102A (and/or another computing device(s) in communication therewith) may process the data to extract features that may be relevant to the customer's purchasing behavior in this example. The ML module 102A may utilize an LLM, a neural network, or similar to transform these features into a high-dimensional space, creating embeddings that capture the intricate patterns and relationships within the data. These embeddings may then be used to populate a vector database, which is designed to facilitate efficient similarity searches and machine learning tasks. In some cases, the embeddings may be further processed by the ML module 102A (and/or another computing device(s) in communication therewith) to ensure that they are suitable for use with specific AI applications, such as recommendation systems or fraud detection models.

In some cases, the API 314 may be utilized to send the dataset to an external provider or a remote server for the purpose of creating embeddings. For example, the computing device 102 may interact with the API 314 to transmit a dataset from the data mart 310 to an external system, such as cloud-based machine learning service. The external system may then create embeddings that represent the data in a high-dimensional space, capturing complex patterns and relationships that are not readily apparent in the raw data.

Once the embeddings are created, they may be sent back to the computing device 102 via the API 314, where they may be integrated into the system's vector database or used directly by the ML module 102A (and/or another computing device(s) in communication therewith) for AI applications. The use of an external provider or remote server for creating embeddings may offer benefits such as scalability, access to specialized algorithms, and computational efficiency. In other examples, once the embeddings are created, they may be sent back to the first data store 106 or to another designated data store within the system 100 for storage and future use. The stored embeddings may then be readily accessible for AI models. In other aspects, once the embeddings are created, they may be stored in the data mart 310.

In some configurations, a scoring engine may determine trust scores for datasets based on the plurality of dimensions. The scoring engine may be designed and implemented in various ways. For instance, the scoring engine could be a standalone software application, a cloud-based service, or an integrated module within a larger data management system. In some aspects, the scoring engine may be resident at, or controlled by, the computing device 102 (and/or another computing device(s) in communication therewith). This configuration allows for centralized processing and management of trust scores for datasets. Additionally, the scoring engine may be resident at, or controlled by, any of the devices 106B, 108B, or 110B, which are servers associated with the first, second, and third data stores, respectively. In such cases, the scoring engine may operate in a distributed manner.

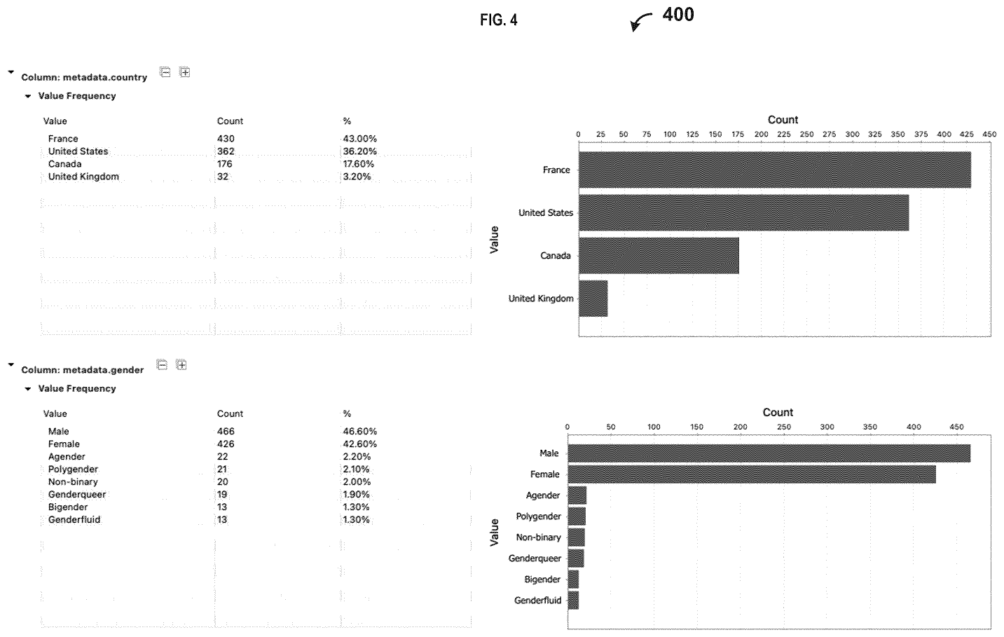

Referring now to FIG. 4, an example user interface 400 associated with the profiling factory 304 of the system 300 is depicted. The user interface 400 may provide a visual representation of the data processed by the profiling factory 304. The user interface 400 may display various metrics and other associated data that result from the dataset being processed by the profiling factory 304. These metrics and associated data may serve as a source of the diversity, accuracy, and/or timeliness dimensions of the trust score. The user interface 400 may also include various features and functionalities, such as data visualization tools, interactive elements, and customizable settings, to enhance the user experience and facilitate data analysis.

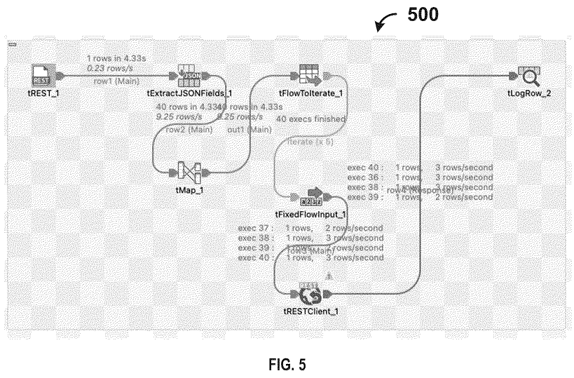

Referring now to FIG. 5, a profiling factory process flow diagram 500 is depicted. The profiling factory process flow diagram 500 provides a visual representation of the data processing tasks performed by the profiling factory 304 of the system 300. These tasks may include data cleaning, data transformation, data integration, and the like. The profiling factory 304 may generate metrics for the diversity, accuracy, and/or timeliness dimensions of the trust score based on the processed data. These metrics may serve as a source of the diversity, accuracy, and/or timeliness dimensions of the trust score.

In some configurations, the data profiling measurements used to determine the trust score could be varied. For example, additional data quality measurements could be included to provide a more comprehensive assessment of the data. These additional measurements could include, but are not limited to, data completeness, data consistency, data redundancy, data relevancy, and the like. Alternatively, or in addition, the existing measurements could be weighted differently to emphasize or de-emphasize particular aspects of the data. For instance, the diversity dimension could be given a higher weight if the AI application requires a wide variety of data sources and formats, while the timeliness dimension could be given a lower weight if the AI application does not require up-to-date data.

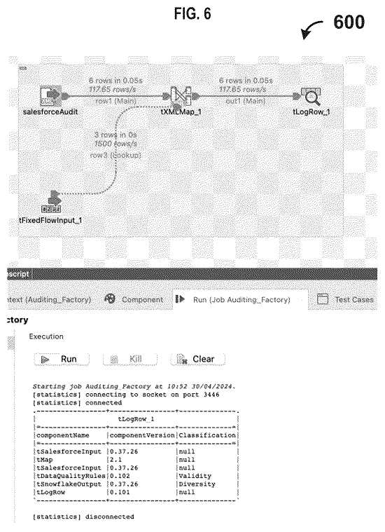

Referring now to FIG. 6, an auditing factory process flow 600 is depicted. The auditing factory process flow 600 provides a visual representation of the data auditing tasks performed by the auditing factory 308 of the system 300. These tasks may include data integrity checking, data compliance checking, data security checking, and the like. The auditing factory 308 may generate metrics for the timeliness, accuracy, security, and/or LLM-readiness dimensions of the trust score based on the processed data. These metrics may serve as a source of the timeliness, accuracy, security, and/or LLM-readiness dimensions of the trust score.

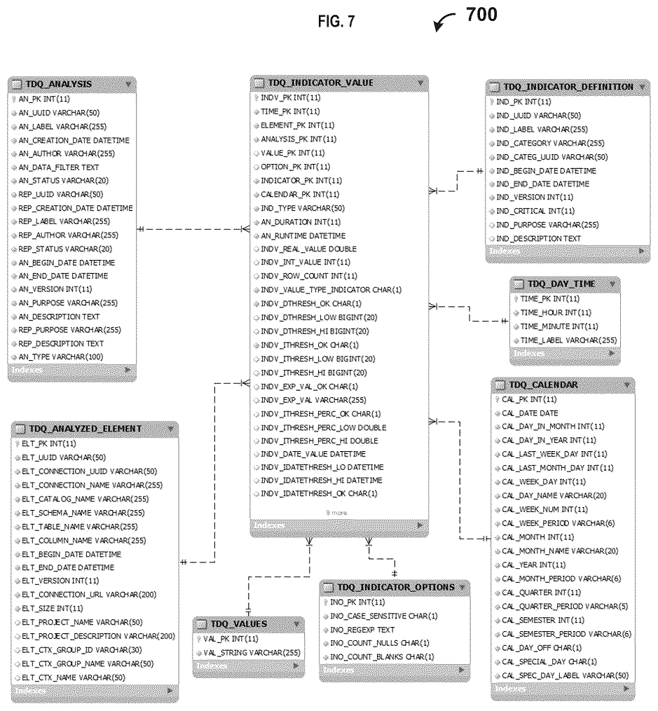

Referring now to FIG. 7, a data mart diagram 700 is depicted. The data mart diagram 700 illustrates various interconnected tables within a data mart, such as the data mart 310. In some aspects, the data mart diagram 700 provides a visual representation of the data organization within the data mart 310. This organization may facilitate efficient data retrieval, data analysis, and data management. The data mart diagram 700 may provide insights into the relationships between different data elements, which may be useful for understanding the structure and semantics of the data.

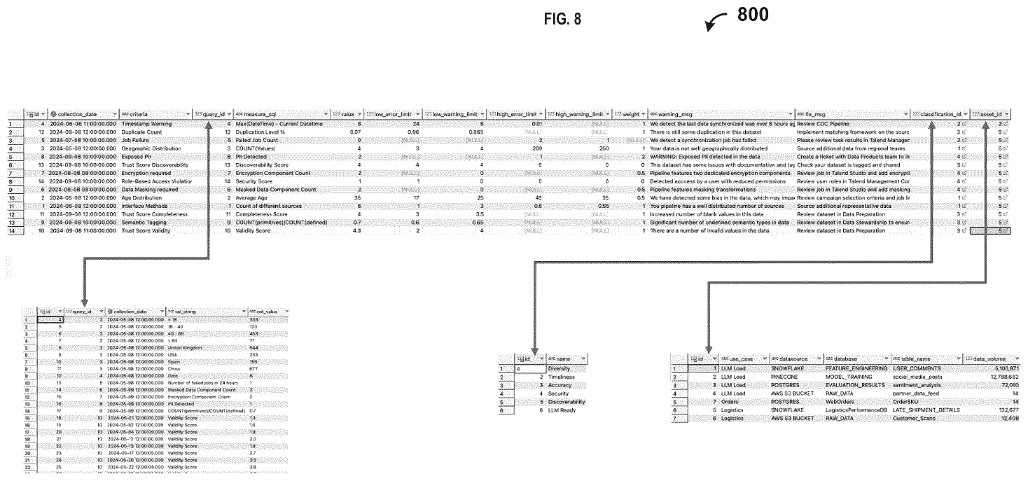

Referring now to FIG. 8, a data mart schema 800 is depicted. The data mart schema 800 provides a visual representation of the data organization within the data mart 310, in some examples. This organization may facilitate efficient data retrieval, data analysis, and data management. Similar to the data mart diagram 700, the data mart schema 800 may also provide insights into the relationships between different data elements, which may be useful for understanding the structure and semantics of the data

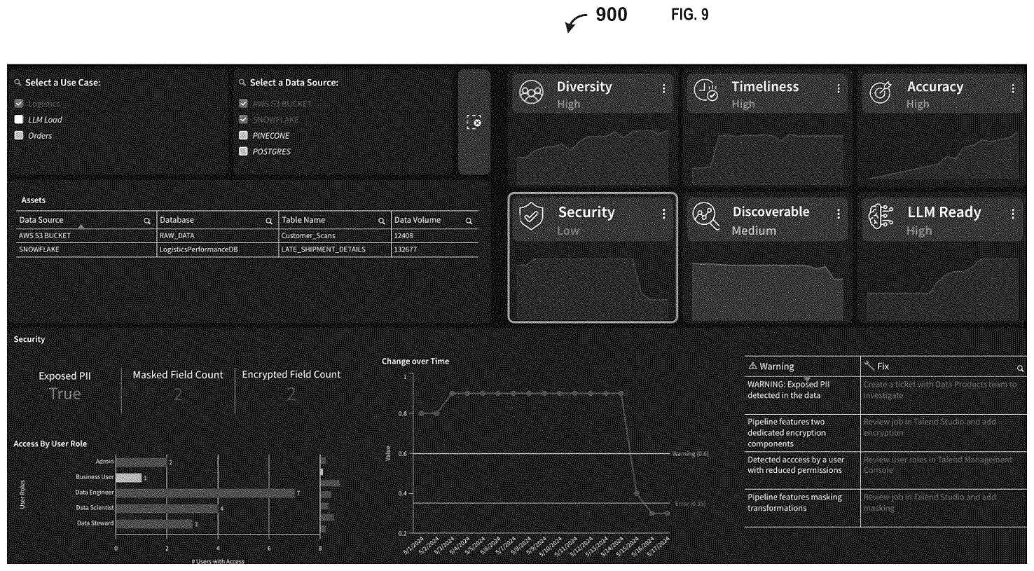

Referring now to FIG. 9, an example dashboard 900 for assessing a trust score is depicted. The dashboard 900 may be part of a user interface to view attributes and characteristics of datasets. The dashboard 900 may comprise an asset list, showing various data sources. The dashboard 900 may comprise indicators for the plurality of dimensions of the trust score: diversity, timeliness, accuracy, security, discoverability, and LLM Ready. Each dimension may be visually represented with a corresponding status, such as “High” for diversity, timeliness, and accuracy, “Medium” for security, and “Low” for Discoverable and LLM Ready in the example shown. The security section of the dashboard 900 may provide additional details, including the detection of exposed Personally Identifiable Information (PII), encryption, data masking, and hard-coded authentication. A graph may also be included in the dashboard 900 to visualize trends related to the trust score.

In some configurations, the user interface, which comprises the dashboard 900, could be designed in various ways. For example, the user interface could be a web-based application, allowing users to access the dashboard 900 from any device with a web browser and an internet connection. In other configurations, the user interface could be a mobile application, providing users with the convenience of accessing the dashboard 900 from a smartphone or tablet. The user interface, including the dashboard 900, could also include different features or functionalities, depending on the specific requirements of the system. For instance, the user interface could include advanced search capabilities, allowing users to quickly locate specific datasets or data elements. The user interface could also include data visualization tools, such as charts, graphs, and heat maps, to help users better understand the data and the trust score. Additionally, the user interface could include customizable dashboards, enabling users to personalize the layout and content of the dashboard 900, etc.

In an example scenario, a user of the computing device 102 may interact with the data mart 310 to request a trust score for an example dataset retrieved from the first data store 106. The user may initiate this process by using the analytics application 312, which may communicate with the data mart 310 via the API 314. The user may specify the dataset for which the trust score is desired, and the system may begin processing the dataset to determine the trust score based on the plurality of dimensions. For the diversity dimension, the system may analyze the dataset to assess its representation across various categories such as demographics, geographic locations, and data sources, for example. The profiling factory 304 may use statistical methods to evaluate the dataset's coverage and variance, ensuring that it is unbiased and comprehensive, as an example. The timeliness dimension may be assessed by examining the dataset's currency and relevance, for example. The system may check any timestamps associated with the data entries and compare them against current date and time and/or against a predetermined schedule to ensure that the dataset is up-to-date and reflective of latest information.

The accuracy dimension may be determined by cross-referencing the dataset with known sources of truth or by applying validation algorithms that check for consistency and correctness of the data, as potential examples. In some examples, the profiling factory 304 may perform these checks to ensure the reliability and trustworthiness of the dataset. The security dimension may be evaluated by the auditing factory 308, which may scan the dataset for vulnerabilities such as exposed PII, and assess the implementation of data protection measures like encryption and data masking, for example. The system may also check for compliance with data security standards and regulations. Other examples are possible as well.

The discoverability dimension may involve assessing how easily the dataset may be found and understood. The system may evaluate metadata quality, documentation, and indexing to ensure that users are able to locate and comprehend the dataset without undue difficulty, for example. The LLM-readiness dimension may be determined by analyzing the dataset's format and structure to ensure compatibility with Large Language Models, etc. The system may check for data normalization, schema consistency, and the presence of any preprocessing steps that may be requisite for LLM consumption, for example. Once a trust score is determined, a user may visualize it via the dashboard 900 (e.g., via the computing device 102).

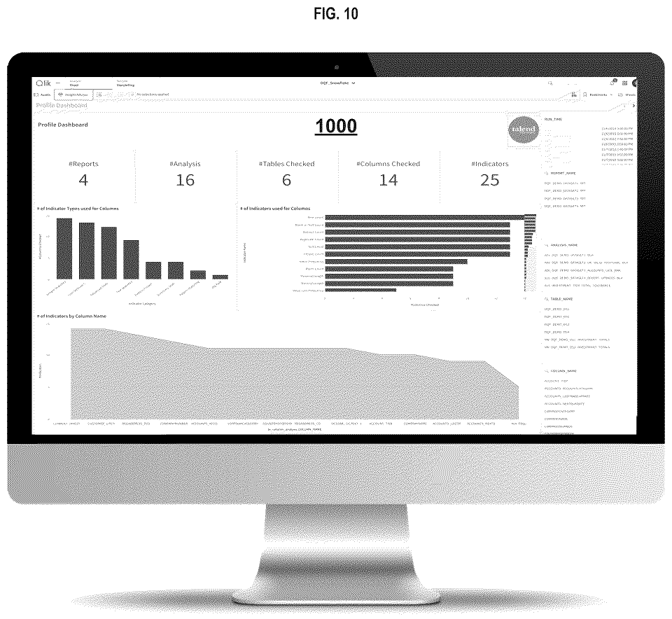

Referring now to FIG. 10, an example trust score report 1000 is depicted. The trust score report 1000 may display various metrics related to an example trust score. The trust score report 1000 may provide visual representations of these metrics through bar charts and graphs, providing insights related to the trust score. In some aspects, the trust score report 1000 may be generated based on the data processed by the profiling factory 304, the collection factory 306, and/or the auditing factory 308 of the system 300. The metrics displayed in the trust score report 1000 may represent the results (e.g., weighted and/or aggregated results) of the data processing tasks performed by these factories.

In some examples, the trust score report 1000 may be output to a computing device via a user interface. The trust score report 1000 may be generated automatically based on the processed data and metrics. For example, a reporting tool may be used to generate the trust score report 1000 based on the data and metrics stored in the data mart 310. The reporting tool may also be used to update the trust score report 1000 as changes are made to the processed data and metrics.

In some examples, a user of the computing device 102 may request that the trust score report 1000 be provided on a regular basis, such as daily, weekly, or monthly, to monitor and analyze the quality of data over time. This recurring delivery of the trust score report 1000 may be facilitated by a scheduling component within the analytics application 312, for example. The user may set up this scheduled reporting by specifying the frequency and format of the trust score report 1000 through the user interface. The system may then utilize the API 314 to interact with the data mart 310, retrieving the latest processed data and metrics for each of the plurality of dimensions of the trust score. The reporting tool may aggregate these metrics over the specified time period, for example. For instance, the trust score report 1000 may show an improving trend in the accuracy dimension as a result of ongoing data cleansing efforts, or it may reveal a gradual decline in the timeliness dimension, prompting the user to investigate potential causes such as delays in data entry or updates.

Furthermore, the system may be configured to alert the user if the trust score falls below a predefined threshold, indicating a potential issue(s), for example. These alerts may be integrated into the user interface, ensuring that the user is promptly informed of any changes in data quality that could impact AI model performance, as an example. For instance, a user may access the dashboard 900 to obtain a quick overview of the current trust scores for various datasets. The dashboard 900 may visually present the trust scores across the plurality of dimensions, allowing the user to identify which datasets meet the desired criteria for AI model training and which do not, for example. If the user notices that the trust score for a particular dataset in the “security” dimension is marked as “Low,” they may delve deeper into the specifics by consulting the trust score report 1000. The trust score report 1000 may provide detailed metrics and analysis, such as a number of exposed PII instances detected or a number of columns checked for encryption, for example, which could explain a low score in the “security” dimension.

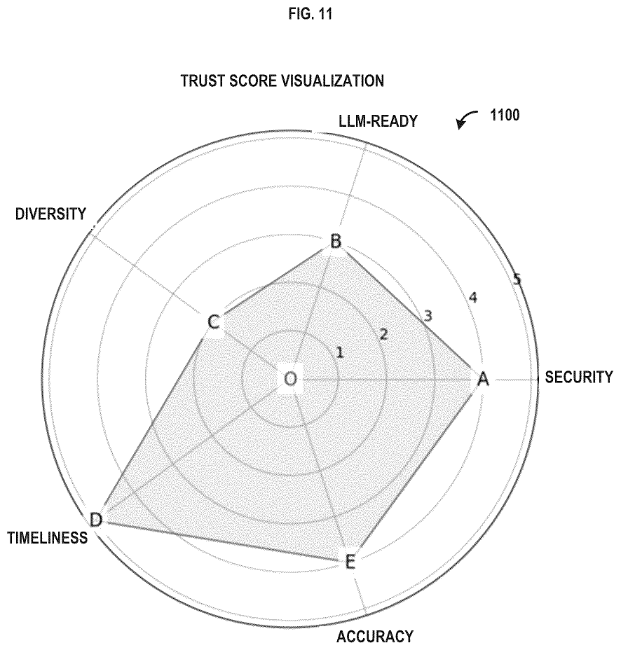

Referring now to FIG. 11, a trust score visualization 1100 is depicted. The visualization 1100 may comprise a radar chart with axes representing the plurality of dimensions of the trust score. The shaded polygon within the radar chart represents the trust score, with points A, B, C, D, and E corresponding to the scores on the security, LLM-readiness, diversity, timeliness, and accuracy axes, respectively. The visualization 1100 may provide a comprehensive and easily understandable representation of the trust score, allowing users to quickly assess the readiness of a dataset for AI use for example.

In some configurations, the trust score may be calculated in various ways. For example, the trust score could be calculated using different mathematical formulas or algorithms, such as:

$$\frac{{\sum }_{i = 1}^{n} {s}_{i} ⋆ {s}_{i + 1 \text{} mod \text{} ( n )}}{{\sum }_{i = 1}^{n - 1} {L}_{i} ⋆ {L}_{i + 1 \text{} mod \text{} ( n )}} .$$

where n is a number of dimensions, s is a score associated with an axis of a plurality of axes, where s ranges from 0 to L, and where L is a scale of the axis and has a maximum value equal to s. Each score may be associated with an axis and range from 0 to L, where L is the scale of the axis and its maximum value is equal to the score s.

As another example, the trust score could be expressed using weights as modifiable parameters:

$$\frac{{\sum }_{i = 1}^{n} {w}_{i} ⋆ {{s}^{′}}_{i} ⋆ {w}_{i + 1 mod ( n )} ⋆ {{s}^{′}}_{i + 1 mod ( n )}}{{\sum }_{i = 1}^{n} {w}_{i} ⋆ {w}_{i + 1 mod ( n )} \text{}} .$$

where n represents a quantity of the plurality of axes, s′ is a score associated with an axis of the plurality of axes, where s ranges from 0 to 1, and where w is a weight of the axis and may be any positive value. This results in possible trust scores between 0 and 1, and therefore the scale of the trust score may be adjusted simply by multiplying the trust score expression by a scaling factor. The second formula may therefore enable custom weights (e.g., as low as a “0” weight) to be used for each axis.

This flexibility in calculation methods allows the trust score to be tailored to specific use cases or requirements. For instance, in some cases, a weighted average formula may be used to calculate the trust score, where each dimension is assigned a weight based on its relative importance. In other cases, a geometric mean formula may be used. The choice of formula or algorithm may depend on factors, such as the characteristics of the data, etc. In addition to different calculation methods, the trust score could also be normalized or scaled differently, depending on the specific requirements of the system. For example, in some cases, the trust score may be normalized to a range of 0 to 1, making it easier to compare trust scores across different datasets. In other cases, the trust score may be scaled to a range of 0 to 100, providing a more intuitive understanding of the trust score (e.g., as a percentage).

In some examples, the dashboard 900 may be configured to display multiple trust score visualizations 1100 over a period of time, such as on a weekly, monthly, or quarterly basis. This temporal display of trust scores may allow users to easily discern changes in the data over a specified period. For example, a user may observe a series of radar charts, each representing the trust score at different time intervals. By comparing these radar charts side by side, the user may notice that the “accuracy” dimension has shown a marked improvement over the last quarter, possibly due to enhanced data validation processes that have been implemented, for example. Conversely, the user may detect a drastic decrease in the “timeliness” dimension, which could indicate that the data is not being updated as frequently as it used to be, for example. Such a trend might prompt the user to investigate the underlying causes, such as delays in data collection or processing pipelines. Similarly, if the “security” dimension shows a sudden drop, this could alert the user to potential breaches or lapses in data protection measures, for example, necessitating immediate action to safeguard the data. Other examples are possible as well.

In some cases, the user may have the ability to adjust the weights of the dimensions for the trust score to align with specific client or company goals. For instance, if a client's primary concern is data security due to the sensitive nature of their data, the user may increase the weight assigned to the “security” dimension within the trust score calculation. This adjustment would reflect the heightened emphasis on security, causing the overall trust score to be more sensitive to changes in the security metrics of the datasets. Similarly, if a company's strategic objective is to ensure that their AI models are trained on the latest data to capture emerging trends, the user may assign a higher weight to the “timeliness” dimension. By doing so, datasets with more current data would receive a higher trust score, incentivizing the maintenance of up-to-date data within the company's data inventory. The user interface of the dashboard 900 may include functionality that allows users to customize the weights of each dimension, such as through a settings panel or a similar configuration tool. For example, users may interact with sliders or input fields to set the weights, and the dashboard may then dynamically recalculate and update the trust score visualizations 1100 to reflect these changes. Other examples are possible as well.

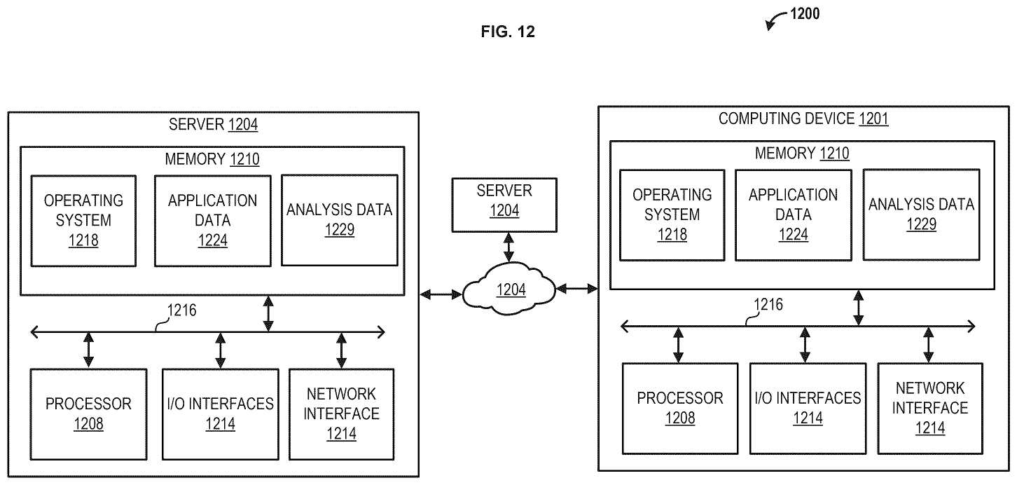

The present methods and systems may be computer-implemented. FIG. 12 shows a block diagram depicting a system/environment 1200 comprising non-limiting examples of a computing device 1201 and a server 1202 connected through a network 1204. Either of the computing device 1201 or the server 1202 may be a computing device, such as any of the devices of the system 100 shown in FIG. 1. In an aspect, some or all steps of any described method may be performed on a computing device as described herein. The computing device 1201 may comprise one or multiple computers configured to store data 1229, and/or the like. The server 1202 may comprise one or multiple computers configured to store data 1224. Multiple servers 1202 may communicate with the computing device 1201 via the through the network 1204.

The computing device 1201 and the server 1202 may be a digital computer that, in terms of hardware architecture, generally comprises a processor 1208, system memory 1210, input/output (I/O) interfaces 1212, and network interfaces 1214. These components (1208, 1210, 1212, and 1214) are communicatively coupled via a local interface 1216. The local interface 1216 may be, for example, but not limited to, one or more buses or other wired or wireless connections, as is known in the art. The local interface 1216 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1208 may be a hardware device for executing software, particularly that stored in system memory 1210. The processor 1208 may be any custom made or commercially available processor, a central processing unit (CPU), an au12iliary processor among several processors associated with the computing device 1201 and the server 1202, a semiconductor-based microprocessor (in the form of a microchip or chip set), or generally any device for executing software instructions. When the computing device 1201 and/or the server 1202 is in operation, the processor 1208 may execute software stored within the system memory 1210, to communicate data to and from the system memory 1210, and to generally control operations of the computing device 1201 and the server 1202 pursuant to the software.

The I/O interfaces 1212 may be used to receive user input from, and/or for providing system output to, one or more devices or components. User input may be provided via, for example, a keyboard and/or a mouse. System output may be provided via a display device and a printer (not shown). I/O interfaces 1212 may include, for example, a serial port, a parallel port, a Small Computer System Interface (SCSI), an infrared (IR) interface, a radio frequency (RF) interface, and/or a universal serial bus (USB) interface.

The network interface 1214 may be used to transmit and receive from the computing device 1201 and/or the server 1202 on the network 1204. The network interface 1214 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 1214 may include address, control, and/or data connections to enable appropriate communications on the network 1204.

The system memory 1210 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 1210 may incorporate electronic, magnetic, optical, and/or other types of storage media. Note that the system memory 1210 may have a distributed architecture, where various components are situated remote from one another, but may be accessed by the processor 1208.

The software in system memory 1210 may include one or more software programs, each of which comprises an ordered listing of executable instructions for implementing logical functions. In the example of FIG. 12, the software in the system memory 1210 of the computing device 1201 may comprise the data 1229, the data 1224, and a suitable operating system (O/S) 1218. In the example of FIG. 12, the software in the system memory 1210 of the server 1202 may comprise the data 1229, the data 1224, and a suitable operating system (O/S) 1218. The operating system 1218 essentially controls the execution of other computer programs and provides scheduling, input-output control, file and data management, memory management, and communication control and related services.

For purposes of illustration, application programs and other executable program components such as the operating system 1218 are shown herein as discrete blocks, although it is recognized that such programs and components may reside at various times in different storage components of the computing device 1201 and/or the server 1202. An implementation of the system/environment 1200 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The present methods and systems may have a variety of use cases across business, technical, and governance domains. For example, financial operations teams may link compute cost with dataset utilization to identify optimization opportunities. As another example, development operations teams may use auditing insights for pre-deployment validation and monitoring of failure trends. Governance teams, as a further example, may benefit from visibility into data ownership, classification, and compliance coverage. AI systems may utilize trust scores to identify high-quality training inputs and LLM-ready datasets. And analytics teams may gain access to accreditation scores for better report interpretation and data confidence, for example. Further, business users may benefit from simplified, governed access to structured metadata for discovery and reuse. Other examples and use case are possible as well.

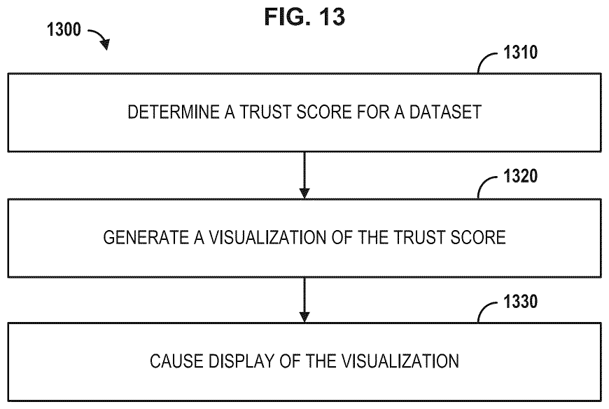

FIG. 13 illustrates a method 1300 for determining and displaying a trust score for a dataset. The method 1300 may comprise three main steps: determining a trust score for a dataset 1310, generating a visualization of the trust score 1320, and causing display of the visualization 1330. In step 1310, the method may determine a trust score for a dataset. This determination may be based on a plurality of dimensions. The plurality of dimensions may comprise diversity, timeliness, accuracy, security, discoverability, and Large Language Model (LLM) readiness. Each of these dimensions may contribute to the overall trust score in different ways. The computing device 102 of system 100 may perform this determination step. The ML module 102A may analyze the dataset to calculate scores for each dimension. In some aspects, the Profiling Factory 304, Collection Factory 306, and Auditing Factory 308 of system 300 may process the dataset to generate the necessary metrics for determining the trust score.

The diversity dimension may assess how unbiased the dataset is across various silos or categories. This may involve analyzing the range and distribution of data points within the dataset. A dataset with high diversity may contain a wide variety of data from different sources or representing different perspectives. The Profiling Factory 304 of system 300 may perform this analysis. The computing device 102 may retrieve data from multiple data stores 106, 108, 110 to evaluate the diversity of sources.

The timeliness dimension may evaluate how up-to-date and real-time the dataset is. This may involve checking the timestamps of data entries and comparing them to current dates or predetermined update schedules. A dataset with high timeliness may contain recent information and may be updated frequently. The Profiling Factory 304 of system 300 may assess this dimension. The servers 106B, 108B, 110B of system 100 may provide timestamp information for the data stored in their respective databases 106A, 108A, 110A.

The accuracy dimension may measure how reliable and trustworthy the data is. This may involve cross-referencing the data with known reliable sources or applying statistical methods to detect anomalies or inconsistencies. A dataset with high accuracy may contain minimal errors and may closely reflect real-world conditions. The Profiling Factory 304 of system 300 may evaluate this dimension. The ML module 102A of system 100 may apply statistical algorithms to detect anomalies in the data.

The security dimension may assess how well the dataset is protected from unauthorized use. This may involve evaluating the presence and effectiveness of data protection measures such as encryption, access controls, and data masking. A dataset with high security may have robust safeguards in place to prevent unauthorized access or data breaches. The Collection Factory 306 of system 300 may assess this dimension. The network 104 of system 100 may provide information about the security protocols used for data transmission.

The discoverability dimension may evaluate how easy it is to find and understand the dataset. This may involve assessing the quality and completeness of metadata, documentation, and indexing associated with the dataset. A dataset with high discoverability may be well-documented and easily searchable within a data catalog or repository. The Collection Factory 306 of system 300 may evaluate this dimension. The vector database 156 of system 150 may provide information about how the dataset is indexed and organized.

The LLM readiness dimension may assess how suitable the dataset is for use with Large Language Models. This may involve evaluating the format, structure, and content of the data to ensure it can be effectively processed by LLMs. A dataset with high LLM readiness may be in a format that LLMs can easily consume and may contain relevant information for language-based tasks. The Auditing Factory 308 of system 300 may assess this dimension. The language model 160 of system 150 may be used to test how well the dataset can be processed by LLMs.

The process of determining the trust score in step 1310 may involve several sub-steps. The method may process the dataset using a profiling factory to generate metrics for the diversity, timeliness, and accuracy dimensions. The profiling factory may perform data quality assessment, data validation, and data classification on the dataset. These operations may help quantify the dataset's characteristics in terms of its diversity, how up-to-date it is, and how accurate its contents are. The Profiling Factory 304 of system 300 may execute these operations. The computing device 102 of system 100 may coordinate the processing tasks. The Profiling Factory process flow diagram 500 may illustrate the sequence of operations performed during this sub-step.

The method may also process the dataset using a collection factory to generate metrics for the security and discoverability dimensions. The collection factory may detect personally identifiable information (PII) and assign semantic type classifications to data fields in the dataset. This process may help evaluate how well sensitive information is protected and how easily different types of data can be identified and understood. The Collection Factory 306 of system 300 may perform these operations. The servers 106B, 108B, 110B of system 100 may provide access to the dataset for analysis.

Additionally, the method may process the dataset using an auditing factory to generate metrics for the LLM readiness dimension. The auditing factory may analyze data processing jobs associated with the dataset to determine the presence of artificial intelligence (AI) components. This analysis may help assess how well-prepared the dataset is for use with Large Language Models and other AI applications. The Auditing Factory 308 of system 300 may conduct this analysis. The Auditing Factory process flow 600 may illustrate the sequence of operations performed during this sub-step. The ML module 102A of system 100 may provide information about AI components used with the dataset.

After generating these metrics, the method may store the trust score and associated metrics in a data mart. The data mart may serve as a central repository for all trust score-related information. The method may then update the trust score based on changes to the dataset over time. This ongoing update process may ensure that the trust score remains current and accurately reflects the evolving state of the dataset. The Data Mart 310 of system 300 may store the trust score and metrics. The data mart diagram 700 and data mart schema 800 may illustrate the structure used for storing this information. The databases 106A, 108A, 110A of system 100 may provide updated data for recalculating the trust score over time.

In step 1320, the method may generate a visualization of the trust score. This visualization may take various forms, but one effective representation may be a radar chart with axes representing each of the plurality of dimensions. The radar chart may provide a clear and intuitive way to display the multidimensional nature of the trust score. The Analytics Application 312 of system 300 may generate this visualization. The computing device 102 of system 100 may process the trust score data to create the visual representation. The trust score visualization 1100 may illustrate an example of the radar chart generated in this step.

The visualization may show the score for each dimension on its respective axis. For example, if the diversity score is high, the point on the diversity axis may be near the outer edge of the chart. Conversely, if the security score is low, the point on the security axis may be closer to the center of the chart. The area enclosed by connecting these points may represent the overall trust score, with a larger area indicating a higher overall trust score. The Analytics Application 312 of system 300 may calculate the positions of these points. The computing device 102 of system 100 may render the visualization based on these calculations.

The method may generate multiple visualizations of the trust score over a period of time to show changes in the dataset. This temporal representation may allow users to track how the trust score and its component dimensions evolve over time. For instance, users may be able to see if the accuracy of the dataset is improving over time, or if the security measures are becoming less effective. The Analytics Application 312 of system 300 may generate these temporal visualizations. The Data Mart 310 may provide historical trust score data for creating these visualizations. The computing device 102 of system 100 may process and render the temporal visualizations.

In step 1330, the method may cause display of the visualization via a user interface. This step may involve rendering the visualization on a screen or other display device, making it visible and accessible to users. The user interface may be part of a larger dashboard or analytics tool that allows users to interact with and explore the trust score data. The dashboard 900 may provide an example of such a user interface. The computing device 102 of system 100 may display the visualization through its I/O interfaces 1212. The API 314 of system 300 may facilitate the transmission of visualization data to the display device.

The display of the visualization may include additional features to enhance its usefulness. For example, the user interface may allow users to hover over or click on different parts of the visualization to see more detailed information about each dimension. It may also provide options to compare trust scores across different datasets or to view historical trends in the trust score. The computing device 102 of system 100 may process user interactions with the visualization. The dashboard 900 may include these interactive features. The profiling dashboard 1000 may provide additional detailed information about the trust score.

The user interface may also include controls that allow users to customize the trust score calculation. For instance, users may be able to adjust the weights assigned to different dimensions based on their specific needs or priorities. If a user is particularly concerned about data security, they may increase the weight of the security dimension in the trust score calculation. The visualization may then update in real-time to reflect these changes. The computing device 102 of system 100 may process these user inputs. The Analytics Application 312 of system 300 may recalculate the trust score based on the adjusted weights. The assistant application 158 of system 150 may provide guidance to users on how to adjust these weights effectively.

Furthermore, the display may include additional contextual information to help users interpret the trust score. This may include explanations of what each dimension represents, guidelines for interpreting the scores, or suggestions for how to improve low-scoring dimensions. The computing device 102 of system 100 may display this contextual information. The assistant application 158 of system 150 may generate explanations and suggestions based on the trust score. The dashboard 900 may incorporate this contextual information into its display.

By implementing this method, organizations may gain valuable insights into the quality and reliability of their datasets. The trust score and its visualization may provide a comprehensive and intuitive way to assess datasets, particularly in the context of AI and machine learning applications. This may help data scientists, analysts, and decision-makers to select the most appropriate datasets for their needs, identify areas for improvement in data quality, and track the effectiveness of data management practices over time. The systems 100, 150, and 300 may work together to implement this method. The computing device 102 may coordinate the overall process. The various factories 304, 306, 308 may perform specialized analysis tasks. The Data Mart 310 may store the results. The Analytics Application 312 may generate visualizations. The dashboard 900 may display the results to users.

The method 1300 may be implemented as part of a larger system for data quality management and AI readiness assessment. It may integrate with existing data management tools and workflows, providing an additional layer of insight and decision support. By helping organizations to better understand and improve the quality of their data, this method may contribute to more effective and reliable AI applications across a wide range of industries and use cases. The computing device 102 of system 100 may serve as the central processing unit for implementing method 1300. The various components of systems 100, 150, and 300 may provide specialized functionality to support different aspects of the method. The processor 1208 and memory 1210 of system 1200 may provide the computational resources needed to execute the method.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, based on a plurality of dimensions, a trust score for a dataset, wherein the plurality of dimensions comprises diversity, timeliness, accuracy, security, discoverability, and Large Language Model (LLM) readiness;
generating a visualization of the trust score; and
causing display of the visualization via a user interface.

2. The method of claim 1, wherein determining the trust score comprises:
processing the dataset using a profiling factory to generate metrics for the diversity, timeliness, and accuracy dimensions;
processing the dataset using a collection factory to generate metrics for the security and discoverability dimensions; and
processing the dataset using an auditing factory to generate metrics for the LLM readiness dimension.

3. The method of claim 2, wherein the profiling factory performs data quality assessment, data validation, and data classification on the dataset.

4. The method of claim 2, wherein the collection factory detects personally identifiable information (PII) and assigns semantic type classifications to data fields in the dataset.

5. The method of claim 2, wherein the auditing factory analyzes data processing jobs associated with the dataset to determine the presence of artificial intelligence (AI) components.

6. The method of claim 1, further comprising:
storing the trust score and associated metrics in a data mart; and
updating the trust score based on changes to the dataset over time.

7. The method of claim 6, wherein the visualization comprises a radar chart with axes representing each of the plurality of dimensions, and wherein the method further comprises displaying, via the user interface, multiple visualizations of the trust score over a period of time to show changes in the dataset.

8. A system comprising:
a processor; and
a memory storing instructions that, when executed by the processor, cause the system to:
receive data associated with a dataset;
determine, based on a plurality of dimensions, a trust score for the dataset, wherein the plurality of dimensions comprises diversity, timeliness, accuracy, security, discoverability, and Large Language Model (LLM) readiness; and
generate a report comprising the trust score.

9. The system of claim 8, wherein determining the trust score comprises:
processing the dataset using a profiling factory to generate metrics for the diversity, timeliness, and accuracy dimensions;
processing the dataset using a collection factory to generate metrics for the security and discoverability dimensions; and
processing the dataset using an auditing factory to generate metrics for the LLM readiness dimension.

10. The system of claim 9, wherein the profiling factory performs data quality assessment, data validation, and data classification on the dataset.

11. The system of claim 9, wherein the collection factory detects personally identifiable information (PII) and assigns semantic type classifications to data fields in the dataset.

12. The system of claim 9, wherein the auditing factory analyzes data processing jobs associated with the dataset to determine the presence of artificial intelligence (AI) components.

13. The system of claim 8, wherein the instructions, when executed by the processor, further cause the system to:
store the trust score and associated metrics in a data mart; and
update the trust score based on changes to the dataset over time.

14. The system of claim 13, wherein the report comprises a visualization of the trust score as a radar chart with axes representing each of the plurality of dimensions, and wherein the instructions, when executed by the processor, further cause the system to generate multiple visualizations of the trust score over a period of time to show changes in the dataset.

15. A non-transitory computer-readable storage medium comprising instructions that, when executed by a processor, cause the processor to:
determine metrics for a dataset using a plurality of processing components;
generate, based on the metrics and a plurality of dimensions, a trust score for the dataset, wherein the plurality of dimensions comprises diversity, timeliness, accuracy, security, discoverability, and Large Language Model (LLM) readiness; and
store the trust score in a data repository.

16. The non-transitory computer-readable storage medium of claim 15, wherein the plurality of processing components comprises:
a profiling factory configured to generate metrics for the diversity, timeliness, and accuracy dimensions;
a collection factory configured to generate metrics for the security and discoverability dimensions; and
an auditing factory configured to generate metrics for the LLM readiness dimension.

17. The non-transitory computer-readable storage medium of claim 16, wherein the profiling factory is configured to perform data quality assessment, data validation, and data classification on the dataset.

18. The non-transitory computer-readable storage medium of claim 16, wherein the collection factory is configured to detect personally identifiable information (PII) and assign semantic type classifications to data fields in the dataset.

19. The non-transitory computer-readable storage medium of claim 16, wherein the auditing factory is configured to analyze data processing jobs associated with the dataset to determine a presence of artificial intelligence (AI) components.

20. The non-transitory computer-readable storage medium of claim 19, wherein the instructions, when executed by the processor, further cause the processor to:
generate a visualization of the trust score as a radar chart with axes representing each of the plurality of dimensions; and
cause display of the visualization via a user interface.
